(19) United States
(12) Patent Application Publication
(10) Pub. No.: US 2019/0039803 A1
(43) Pub. Date: Feb. 7, 2019

(54) VOLATILES PRESERVING PACKAGING AND METHODS

(71) Applicant: Vireo Health Inc, Minneapolis, MN (US)

(72) Inventor: Eric A. Greenbaum, Denver, CO (US)

(73) Assignee: Vireo Health Inc, Minneapolis, MN (US)

(21) Appl. No.: 15/971,851

(22) Filed: May 4, 2018

Related U.S. Application Data
(60) Provisional application No. 62/501,273, filed on May 4, 2017.

(51) Int. Cl. B65D 81/24; B65D 81/20; A23L 27/00; B65D 65/42

(52) U.S. Cl. CPC B65D 81/24; B65D 81/2076; A47J 47/10; B65D 65/42; A23L 27/88

(57) ABSTRACT

A packaging system and methods for the preservation of volatile chemicals in a product containing volatile chemicals is disclosed. The packaging system generally has one compartment adapted for the storage of the volatiles containing product in communication with a second compartment which contains a source of volatile chemicals such that the volatile chemicals disperse into the first compartment. The make up of the volatile chemicals in the second compartment are selected either to match the naturally occurring volatile chemicals in the product to be packaged or to complement the naturally occurring volatile chemicals in the product to be packaged. In this way, the naturally occurring volatiles content of the product can be preserved or odors and flavors that do not naturally occur within the product can be added. In some case, the product to be packaged is cannabis.

### FIELD OF THE INVENTION

The present invention relates generally to packaging for volatiles containing products; in particular plant-based products such as herbs, spices, and cannabis.

### BACKGROUND OF THE INVENTION

Cannabis for both recreational and medicinal uses is increasing in popularity in the United States and around the world. While the major cannabinoids (THC and CBD) receive most of the attention, terpenes, terpinoids, flavonoids, and other volatile (hereinafter “volatiles”) components are increasingly recognized as important. Volatiles impart flavor and aroma to cannabis and are also recognized to have important pharmacological effects. Unfortunately, by their nature, volatiles are volatile and can quickly evaporate from cannabis thereby depriving users of their benefits.

Similar issues arise in the use of herbs and spices which contain volatile chemical components that are lost to the environment over time.

### SUMMARY OF THE INVENTION

As specified in the Background Section above, there is a need in the art to develop new devices and methods to preserve the volatile fraction in volatiles containing products, such as, for example, herbs, spices, cannabis and cannabis products.

Thus, an embodiment of the present invention is a package for preserving the volatile content of a product comprising a first compartment for storing a product; a second compartment; wherein the first compartment and the second compartment are in communication with each other; wherein the second compartment contains a source of volatile chemical compounds; and wherein the volatile compounds in the source for volatile compounds are selected to compliment the odor and or flavor of the product being stored in the first compartment. In some embodiments the package is a jar. In some embodiments the package is a bag.

In an embodiment the invention is a volatiles emitting insert for use in a product package comprising a dispersion matrix that has been infused with a source of volatiles. In some embodiments the volatiles matrix is disposed within a housing.

In an embodiment the invention is a method for preserving the volatiles content of a volatiles containing product comprising the steps of determining a mixture of volatiles that would complement the volatiles containing product, infusing or making a volatiles source with the mixture of volatiles that would complement the volatiles containing product, packaging the volatiles containing product with the volatiles source. In some embodiments a volatiles source is added to a packaged volatiles containing product after the product has been packaged either at the time of packaging or after packaging.

### BRIEF DESCRIPTION OF THE DRAWINGS

FIG. 1 shows an example of jar holding a volatiles containing product.

FIG. 2 shows a flow diagram of a method for preserving the volatiles content of a volatiles containing product.

FIG. 3 shows an example of a jar style package for a volatiles containing product.

FIG. 4 shows examples of inserts for use in packages of volatiles containing products.

FIG. 5 shows another example of a jar style package for a volatiles containing product.

FIG. 6 shows examples of sources of volatiles for use in various embodiments of the invention.

FIG. 7 shows an example of a bag style package for a volatiles containing product.

FIG. 8 shows an illustration of the equilibrium dynamics that cause loss of volatiles in volatiles containing products.

FIG. 9 shows examples of the terpene content of various strains of cannabis.

### DETAILED DESCRIPTION

These and other systems, methods, objects, features, and advantages of the present disclosure will be apparent to those skilled in the art from the following detailed description of the embodiments and drawings.

All documents mentioned herein are hereby incorporated in their entirety by reference. References to items in the singular should be understood to include items in the plural, and vise versa, unless explicitly stated otherwise or clear from the text. Grammatical conjunctions are intended to express any and all disjunctive and conjunctive combinations of conjoined clauses, sentences, words, and the like, unless otherwise stated or clear from context.

The term volatiles containing product means any product that contains volatile chemicals that are beneficial to the product and which may be lost to the environment over time thereby decreasing the value or perceived value of the product. Examples include herbs, spices, cannabis, and other natural products.

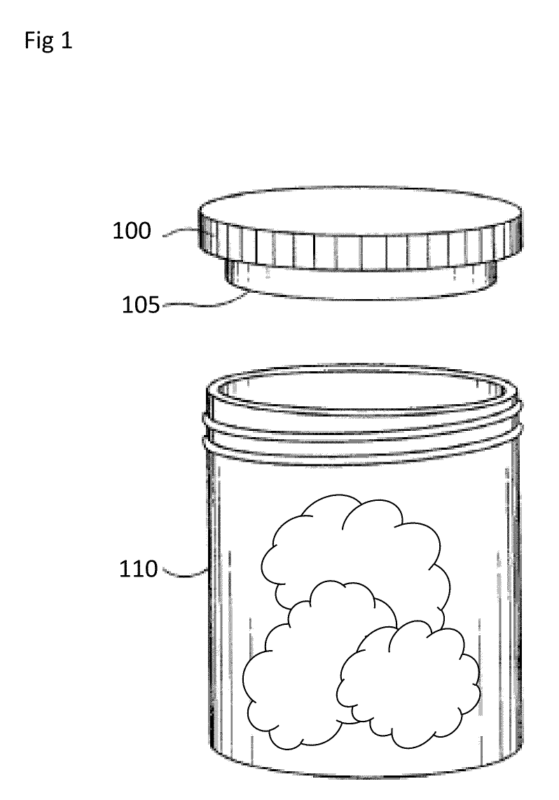

FIG. 1 shows a jar style package for a volatiles containing product. The jar style packaging generally has a main storage compartment (110) for holding the volatiles containing product and a lid/cap (100). In some embodiments the lid/cap may further comprise a volatiles dispersion matrix disposed within or affixed to, the underside of the lid/cap (105).

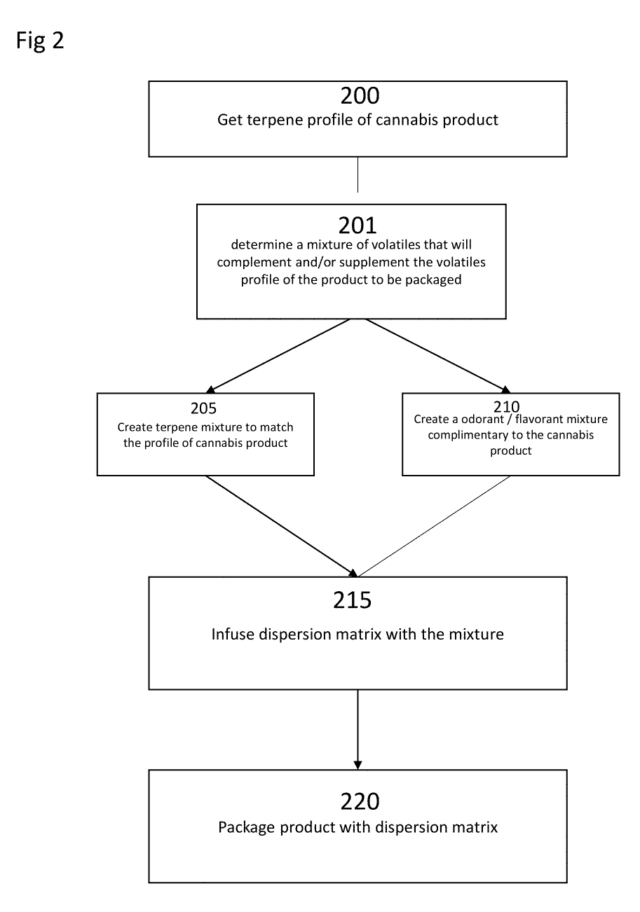

FIG. 2 shows a flow diagram of a method for preserving and/or supplementing the volatiles in a volatiles containing product. Generally, the process begins by obtaining the volatiles profile of the product (200). For example, if the product is cannabis, this may entail obtaining the terpene profile of the cannabis to be packaged. This can be done using standard analytical laboratory methods, such as, for example, gas chromatography mass spectrometry (GCMS). The next step is to determine a mixture of volatiles that will complement and/or supplement the volatiles profile of the product to be packaged (201). In some embodiments this determination may be as simple as matching the entire or part of the volatiles profile of the product to be packaged. In some embodiments this determination may include the identification of volatiles that supplement or complement the volatiles profile of the product. Some embodiments include the incorporation of both naturally occurring volatiles as well as volatiles that do not naturally occur in the product. The next step in the process is to create a mixture of volatiles to either match (205) the profile of the product to be packaged, or complement (210) the profile of the product to be packaged. This can be done by any methods known to those skilled in the art. Many volatiles are commercially available by odorant/flavorant suppliers. For example, many terpenes are available commercially. They can be mixed in the proportions desired by standard food/laboratory practices. The next part of the process is to infuse a dispersion matrix with the volatiles mixture (215). In some embodiments the dispersion matrix undergoes secondary packaging, such as for example in a packet or capsule. The next step in the process is to package the volatiles containing product in such a way so as the dispersion matrix is in communication with the air in the package containing the product (220). In some embodiments the dispersion matrix may be sold as an “after-market” accessory for end-users to place in a package of a volatiles containing product.

In some embodiments the process is used to precisely match the volatiles profile of specific strains of cannabis or other volatiles containing product. In some cases this will be a custom product for specific suppliers of unique cannabis strains, or other volatiles containing product. In other embodiments, the general volatiles profile of generic cannabis strains will be produced.

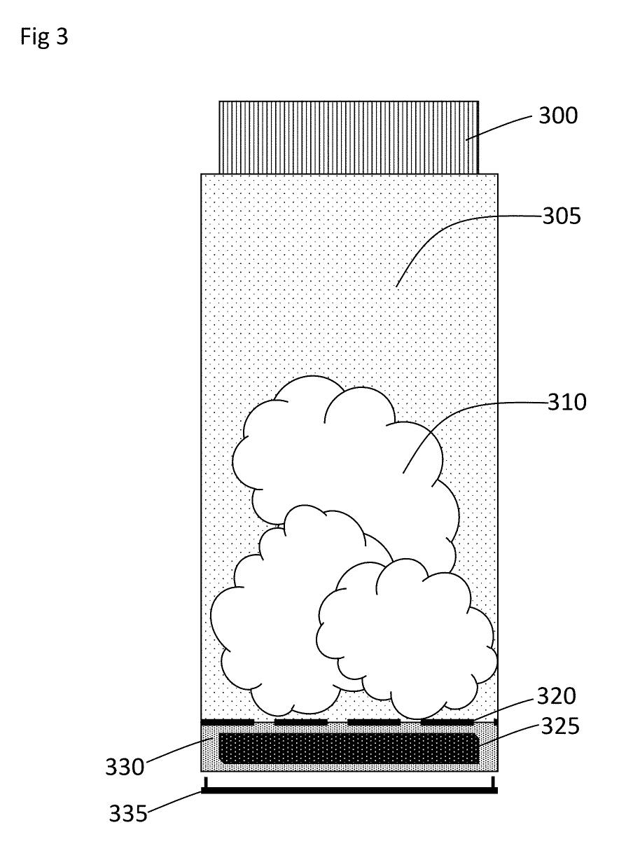

FIG. 3 shows an example of a jar style package for holding a volatiles containing product (310). This embodiment has a primary container portion (305) with a child resistant lid (300) which is used to hold the volatiles containing product and a secondary compartment (330) which is used to hold the volatiles dispersion matrix (325). In this example the secondary compartment is located on a bottom aspect of the jar style package. A permeable barrier (320) separates the primary container portion from the secondary compartment so the volatiles in the dispersion matrix (325) can permeate the air in the primary container portion. A cap (335) on the bottom of the jar style package enables the placement and sealing off of the volatiles dispersion matrix.

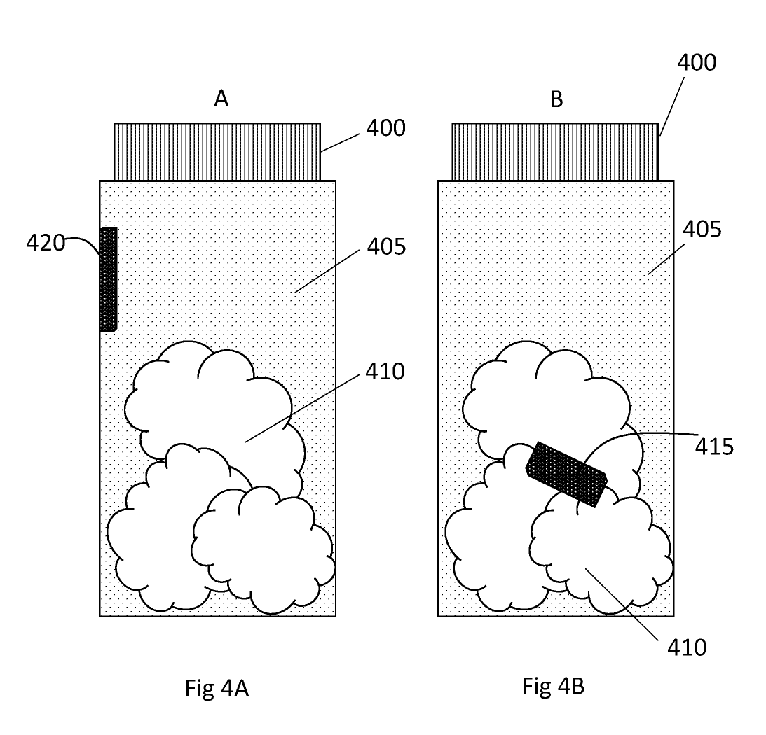

FIG. 4 shows two different embodiments of insert-style dispersion matrix units. FIG. 4a shows a dispersion matrix unit that has an adhesive component. The adhesive component enables the dispersion matrix unit to be affixed (420) to the inside of virtually any type of package used to hold a volatiles containing product (410). In this figure, the package shown is a jar-style package (405). In some embodiments, the adhesive style dispersion matrix is affixed to the package facing surface of a cap for the package (400). FIG. 4b shows a dispersion matrix unit (415) that is placed inside the package but not affixed to the package. This style of dispersion matrix unit may take any form known to those having skill in the art and particularly contemplates packets and capsules.

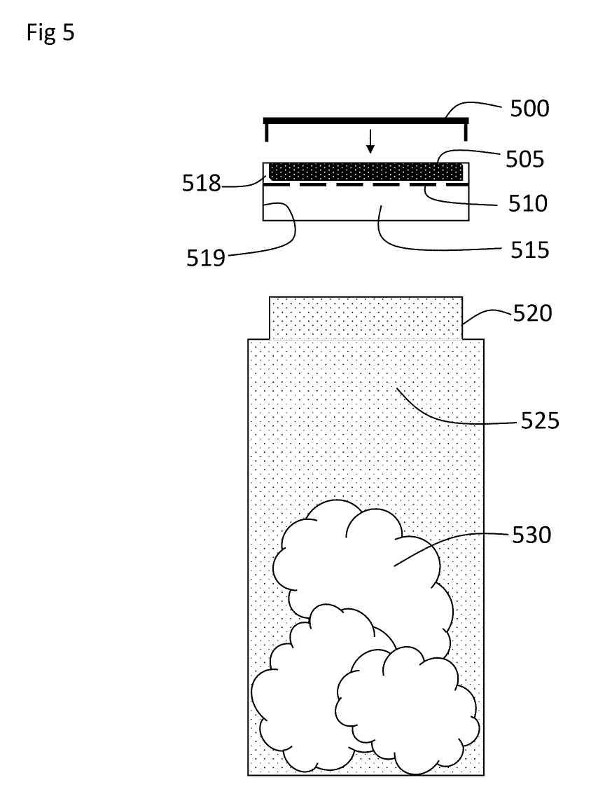

FIG. 5 shows a jar style package (525) used in the packaging of a volatiles containing product (530) in which the dispersion matrix is disposed within the cap (515) of the jar style package. The cap comprises a package engaging portion (519,) such as, for example, threads that engage complementary threads on the body of the jar style package (520); and a dispersion matrix compartment (518) adapted to house a dispersion matrix unit (505). A permeable layer (510) separates the dispersion matrix compartment from the package engaging portion so that the volatiles contained within the dispersion matrix can disperse into the head space of the package. A cap (500) on the top side of the package cap enables the dispersion matrix to be placed within the dispersion matrix compartment and then closed off.

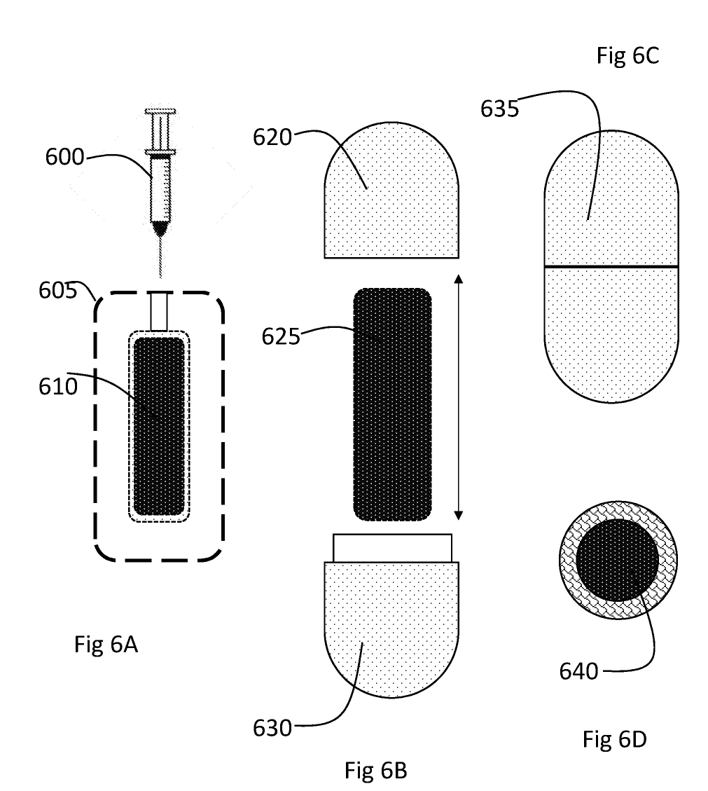

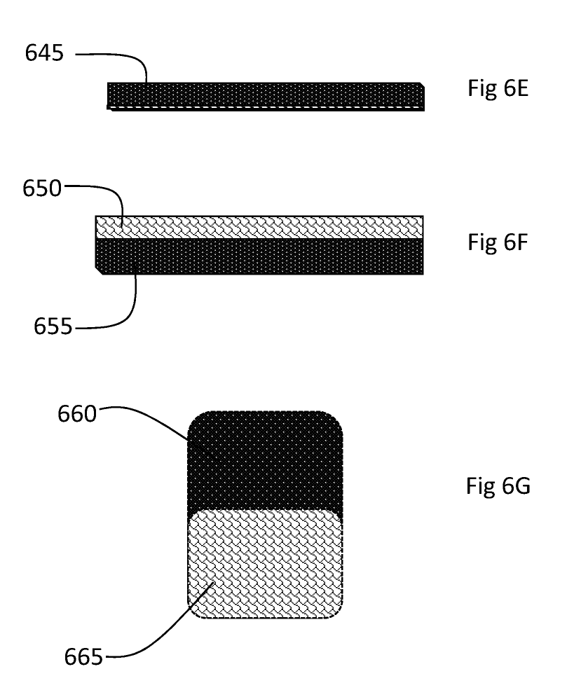

FIGS. 6A-6G show a variety of dispersion matrix inserts. In some embodiments the dispersion matrix is made up of a volatiles containing core with the core disposed within a housing and/or barrier layer. In some such embodiments, the core (610) may be manufactured within the housing (605) so that a solution of volatile chemicals can later be injected (600) into the core as shown in FIG. 6A. In some embodiments the volatiles containing core is made up of an absorbent material such as blotter paper or the like. In some embodiments the volatiles containing core is a oil based gel, in some cases that is solid or semisolid gel. In some embodiments the dispersion matrix insert is a capsule (625). In the capsule-style embodiments, a dispersion matrix core (625) is impregnated with solution of volatile chemicals and disposed between a top half (620) and a bottom half (630) of a capsule as shown in FIG. 6B. FIG. 6C illustrates the top half (620) and bottom half (630) combined into capsule (635). In FIG. 6D, a cross section of a capsule style insert (640) shows the dispersion matrix seated within the capsule body. In some embodiments the dispersion matrix insert is a packet. In some embodiments the dispersion matrix insert is a laminate. In some embodiments the dispersion matrix insert further comprises an adhesive layer so the dispersion matrix insert can be fixed to the package.

In general the dispersion matrix is a material or group of materials that act as a reservoir for volatiles and release those volatiles in a controlled manner over time. These types of matrices are known in the art and practitioners will be able to select the dispersion matrix that best suits their needs depending on the volatile chemicals to be used and the desired rate(s) of dispersion. Some examples include laminates, blotter papers, glass foam, ceramic foam, metal mesh, silicone rubber matrices, polymers, and combinations thereof.

In an embodiment the dispersion matrix is a hydrophobic or other absorbent material capable of absorbing an oil solution with a defined volatiles composition. In some embodiments the absorbent material includes a woven or non woven material such as cellulose, rayon, cotton, or other polymeric material treated in such a fashion as to enable it to readily absorb oil based solutions. In some embodiments the solution treated blotter is then laminated between layers of a permeable barrier film that will transmit the volatiles. The volatiles transmission rate is determined by the type of barrier used, its thickness and porosity. The volatiles transferred is also determined by the area of the barrier exposed to the solution.

In some embodiments the dispersion matrix is a silicone rubber into which the volatiles mixture has been impregnated.

In some embodiments the dispersion matrix is a multi-laminate sustained release device (645) capable of releasing volatiles at a controlled rate for a prolonged period of time and having a first layer of a pressure sensitive adhesive release liner for providing a protective peel strip for the device, a second layer of silicone pressure sensitive adhesive for adhering the device to a substrate to which it is applied, a third layer of a volatiles impregnated matrix of a silicone material selected from the group consisting of silicone elastomers, silicone elastomers having adhesive characteristics, and elastomeric silicone pressure sensitive adhesives, and a fourth layer of a permeable facestock backing member on the surface of the device for controlling the rate of release of the volatiles from the impregnated matrix. FIG. 6E shows a multi-laminate sustained release device (645).

In some embodiments the dispersion matrix is coupled with a humidity controlling element such as that described in US patent publication US20150328584 A1 herein incorporated by reference. In such embodiments dispersion matrix may be a dual layered design wherein the the humidity controlling element (650) may be stacked on top or below the dispersion matrix (655) as shown in FIG. 6F. In other embodiments, the humidity controlling element (665) may be disposed side-by-side with the dispersion matrix (660) as shown in FIG. 6G.

To make the volatiles solution the desired recipe/proportion of the desired volatiles is determined. This can be done by determining the volatiles profile of the product to be stored. Alternatively a de-novo volatiles profile can be created to complement the product. Next the volatiles are mixed together in the desired proportions. In some embodiments the volatiles solution is diluted into a suitable carrier, such as MCT or other inert oil. It has been observed that some individual volatiles evaporate more readily than others. In such cases it may desirable to disproportionately represent those volatiles in the matrix.

The dispersion matrix can include indicia disposed on an outer surface of the dispersion matrix. The indicia can include artwork, a logo, an advertisement, an instruction, a brand, a trademark, etc. The indicia can be formed by printing on the outer surface, molded into the material of the outer surface, etc.

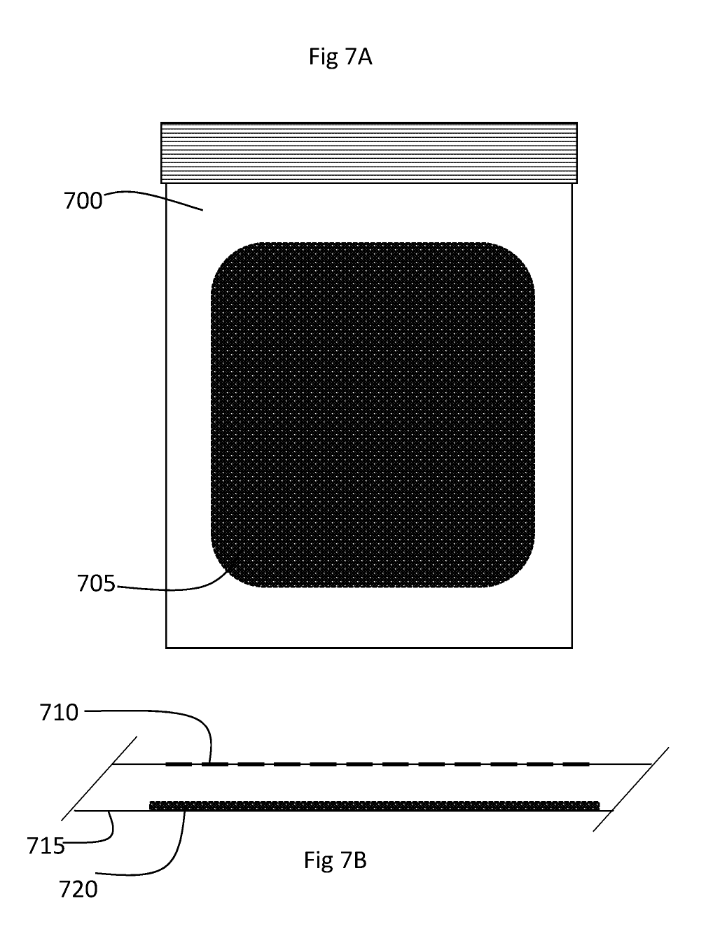

FIG. 7A shows an example of a bag style package (700) incorporating a dispersion matrix (705). In some embodiments, as described above, the dispersion matrix insert can be placed inside the bag style package as shown in FIG. 7B. In an embodiment the bag has a front side and a back side (715) wherein the back side of the bag is perforated (710) and the volatiles insert (720) is placed over the perforations.

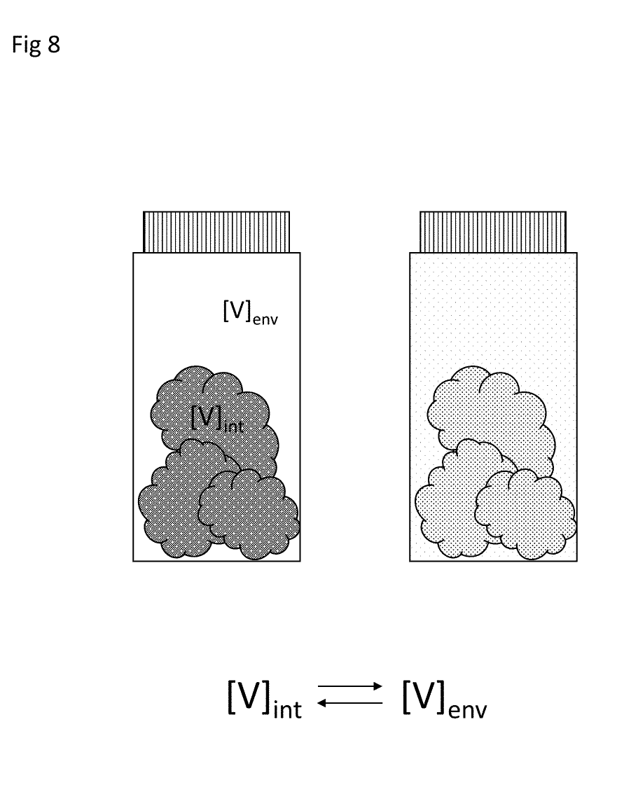

FIG. 8 is an illustration of the equilibrium dynamics that play a role in maintaining the volatiles content of packaged products.

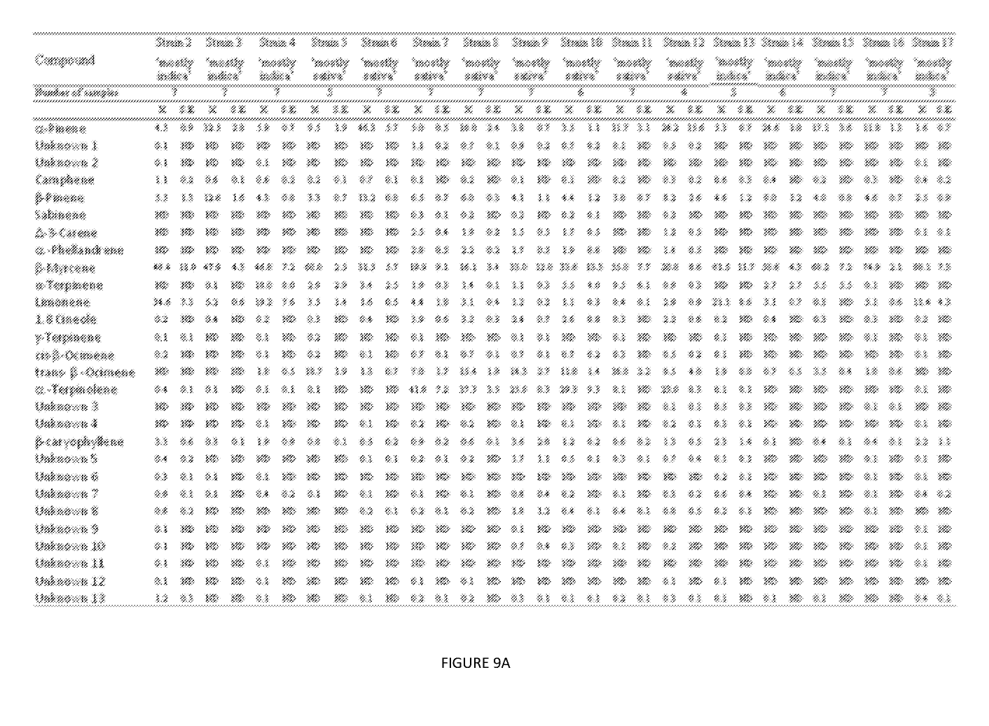

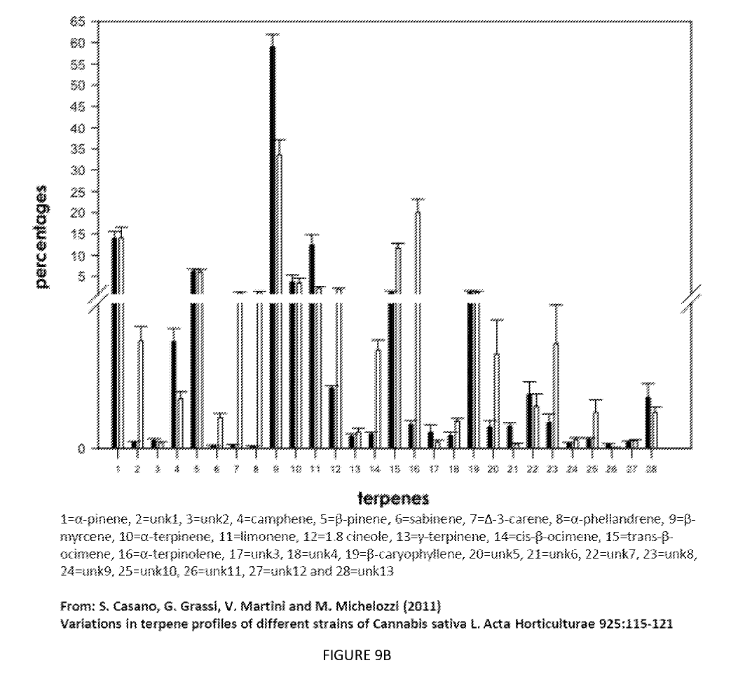

FIG. 9A shows the terpene content of some characteristic cannabis strains. FIG. 9B shows variations in terpene profiles of different strains of cannabis. These profiles may be used to create the volatiles mixtures to be integrated into the dispersion matrix.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

With respect to the above, it is to be understood that the invention is not limited in its application to the details of construction and to the arrangement of the components listed or the steps set forth in the description or illustrated in the drawings. The various apparatus and methods of the disclosed invention are capable of other embodiments, and of being practiced and carried out in various ways that would be readily known to those skilled in the art, given the present disclosure. Further, the terms and phrases used herein are for descriptive purposes and should not be construed as in any way limiting.

As such, those skilled in the art will appreciate that the conception upon which this disclosure is based may be utilized as a basis for designing other inventions with similar properties. It is important therefore that the embodiments, objects, and claims herein, be regarded as including such equivalent construction and methodology insofar as they do not depart from the spirit and scope of the present invention.

What is claimed is:

1. A package comprising:
A first compartment for storing a product;
A second compartment;
Wherein the first compartment and the second compartment are in communication;
Wherein the second compartment contains a source of volatile chemical compounds; and
Wherein the volatile compounds in the source for volatile compounds are selected to compliment the odor and or flavor of the product being stored in the first compartment.

2. A device for influencing the odor and or flavor profile of a packaged product:
a. A source of odorant/flavorants absorbed into an absorbent material wherein the absorbent material is disposed within a permeable housing.

3. Bag with a front side and back side and wherein the back side is perforated such that an adhesive sticker further comprising a dispersion element is placed against the bag the perforated back side will be covered by the sticker thereby achieving communication between the dispersion element and the main compartment of the bag.
